(19) United States
(12) Patent Application Publication
(10) Pub. No.: US 2016/0198839 A1
(43) Pub. Date: Jul. 14, 2016

(54) CARD HOLDER WITH TAB

(71) Applicant: Thumbzees, LLC, Lufkin, TX (US)

(72) Inventors: Joshua Andrew Jamison, Lufkin, TX (US); Bradley Carlton Dearing, Lufkin, TX (US)

(73) Assignee: THUMBZEES, LLC, Lufkin, TX (US)

(21) Appl. No.: 14/592,923

(22) Filed: Jan. 9, 2015

(51) Int. Cl. A45F 5/10; B66F 19/00

(52) U.S. Cl. CPC A45F 5/10; B66F 19/00

(57) ABSTRACT

This invention relates to an apparatus for quickly and easily locating and obtaining at least one credit card, ID card, driver's license, business card, and the like from a card carrying device. More particularly, an elastic circular band secured at one end with an elongated tab in such a way to enable quick and easy retrieval from the confined space is disclosed.

### BACKGROUND OF INVENTION

1. Field of the Invention

This invention relates to an apparatus for quickly and easily locating and obtaining at least one credit card, ID card, driver's license, business card, and the like from a card carrying device.

2. Description of Related Art

Credit cards, ID cards, driver's license, business cards, and other types of cards have become an important part of a person's everyday life. Typically, a person will store one or more of these cards in their wallet or purse at all times. Because the cards are stored in confined spaces, they can be difficult to remove from tight wallet or purse slots. Additionally, important, personal information is often displayed on the face of the cards, posing a risk of identity theft.

Adhesive solutions for finding and retrieving cards have been proposed, such as the “Adhesive Retrieval Tab for Removal of Credit Card Style Item” (US Patent Application No. US 2014/0034227) and the “Apparatus and Method for Assisting the Retrieval of Identification or Credit Cards From a Wallet” (US Patent Application No. US 2013/0170938 A1). Non-adhesive solutions have also been proposed for this use, such as the “Card Retriever for Retrieving Small Card-Like Objects From a Wallet” (U.S. Pat. No. 8,726,953 B2).

Disadvantageously, the adhesive solutions are dependent on the adhesive to remain clean and sticky to maintain the bond with the card. On the other hand, the non-adhesive solutions previously proposed often must be removed before the card is used. Neither of these approaches provide additional security against identity theft by covering important visual information on the card. There is a need for a device that will 1) allow for easy retrieval of the card from a confined space, 2) allow the user to keep it in place during use, and 3) provide a level of information security by covering important visual information on the card.

### BRIEF SUMMARY OF THE INVENTION

In accordance with the invention, a circular band is secured in such a way that it surrounds the card and also provides an elongated tab as a method for easy location, identification, and retrieval of the card from the confined location. Additionally, the design of the current invention allows it to stay in place during use and covers important visual information on the card to provide a level of information security.

If desired, particular embodiments can be made of different sizes or colors, have numbers or letters on the outside of the circular band or pull-tab, or can contain other uniquely identifiable characters.

The invention may be used to particular advantage as bank or credit card marketing tool, with the circular band or pull-tab displaying the unique branding of a particular bank or credit card company.

Other features and advantages of the present invention will become apparent from the following more detailed description, taken in conjunction with the accompanying drawings, which illustrate, by way of example, the principles of the presently described apparatus and method of use.

### BRIEF DESCRIPTION OF THE SEVERAL VIEWS OF THE DRAWING(S)

The accompanying drawings illustrate various exemplary implementations and are part of the specification. The illustrated implementations are proffered for purpose of example, not for purpose of limitation.

Illustrated elements will be designated by numbers. Once designated, an element will be identified by the identical number throughout. Illustrated in the accompanying drawings is at least one of the best mode embodiments of the present disclosure. In such drawings:

FIG. 1 is an isometric top view of an embodiment of the assembly disclosed herein.

FIG. 2 is a plain top view of an embodiment of the presently described apparatus holding a card.

FIG. 3 is a plain front view of depicting an example of the presently described apparatus holing a card in the pouch of a card carrying case such as a wallet or purse.

### DETAILED DESCRIPTION OF THE INVENTION

The present invention will be more fully understood and appreciated by reading the following Detailed Description in conjunction with the accompanying drawings, wherein like reference numerals refer to like components.

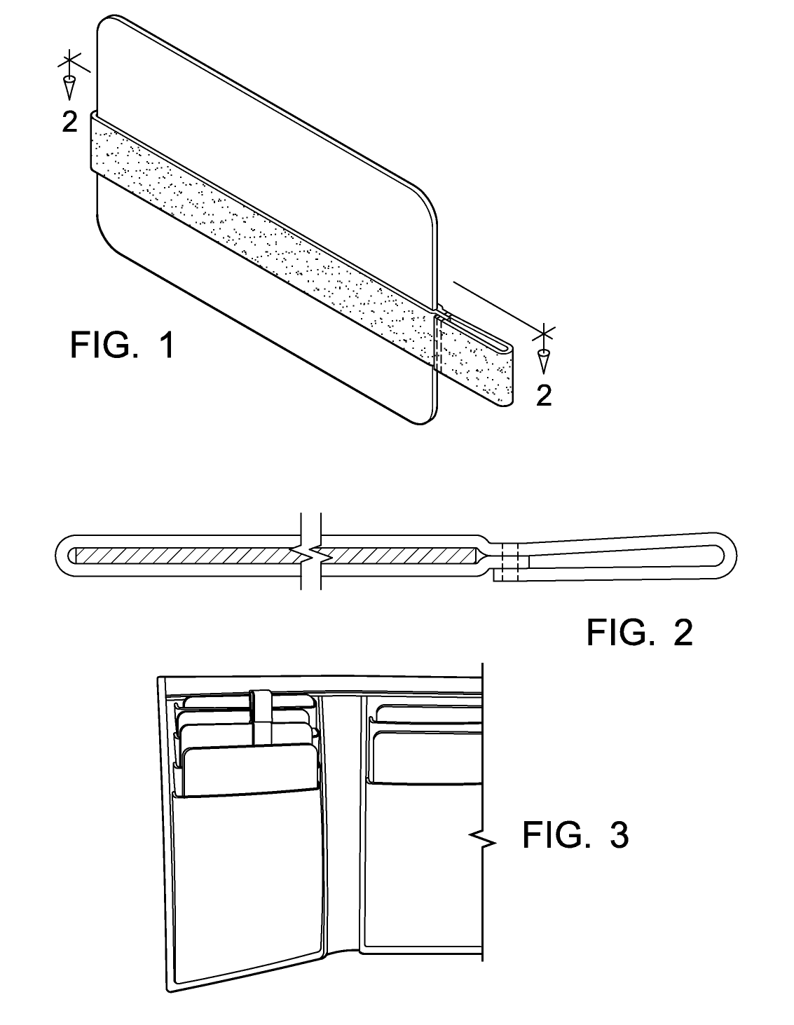

Referring to FIG. 1, an embodiment of the card holder with tab includes circular band 3. Circular band 3 may be constructed of any material of sufficient strength to withstand the tensile force of pulling a card from a pocket or sleeve. It is preferred that the circular band be constructed of elastic material so that the circular band remains in contact with the card when in use and yet does not easily fall off the card. The circular band may be of various thickness, but preferably the circular band should be thin so that it can easily slip into the pocket or sleeve of a purse or wallet.

Additionally, circular band 3 may be clear or opaque. It is preferred that circular band 3 be opaque in color so that it can cover sensitive information on the card, such as the numbers on a credit card, providing a measure of information security not found in the prior art.

Further, circular band 3 may be of various widths. It is preferred that the width of circular band 3 be somewhat less than the width of the card, but wide enough so that it can cover sensitive information on the card and so that the strength of circular band 3 is maintained. In the preferred embodiment, the width of circular band 3 is wide enough to cover the numbers on a credit card yet narrow enough that the credit card can slide through a credit card machine without requiring removal of circular band 3.

Referring to FIG. 2, circular band 3 is secured at connection point 2 to form elongated tab 1. The connection at connection point 2 may be secured in various ways; in the preferred embodiment, connection point 2 is formed by sewing two sides of circular band 3 together at a single point. Such connection point could also be secured by any suitable adhesive, epoxy, resin, rivet, staple, pin, or other methods known in the art.

Referring to FIG. 2, connection point 2 secures tab 1 to circular band 3. In the preferred embodiment, tab 1 is a loop of material with both ends of the loop attached to connection point 2. The present inventor has found that the loop design provides the best grip for pulling the card from a slot in a wallet or purse. In other possible embodiments, tab 1 may be a single member connected to circular band 3 at connection point 2.

Elongated tab 1 may be of various colors or include a sign, a symbol, a trademark, a number, a letter, a design, other distinguishing marks, or combinations thereof. As a non-limiting example, elongated tab 1 may include a trademark of a bank or credit card company that distinctively identifies that card. As another example, the distinguishing marks or colors can be used to organize cards for different purposes. Further, the distinguishing marks on tab 1 may also be suitable for tactile identification of the card, such as Braille, jewelry, or texturing or other means known in the art allowing the identification of a particular card without the need for visual examination.

Elongated tab 1 may also be made of various materials. In the preferred embodiment, tab 1 is constructed of the same elastic material as circular band 3 for ease of manufacture. However, other embodiments may require different materials for elongated tab 1 known in the art, such as metal, cloth, or plastic.

Although the present invention has been described with respect to specific details, it is not intended that such details be regarded as limitations on the scope of the invention, except to the extent that they are included in the accompanying claims. It will thus be appreciated that those skilled in the art will be able to devise numerous alternative arrangements that, while not shown or described herein, embody the principles of the invention and thus are within its spirit and scope.

I claim:

1. An apparatus for locating and removing a card from a card carrying device, comprising:
a circular band, said circular band sized to form a snug connection with the card;
an elongated tab of material, said elongated tab sized to accommodate gripping by an individual's fingers; and
a connection point securing the elongated tab to the circular band

2. An apparatus as in claim 1, wherein said elongated tab is constructed as a loop of material with both sides of the material connected to said connection point.

3. An apparatus as in claim 1, wherein said circular band is made of elastic material.

4. An apparatus as in claim 1, wherein said elongated tab is made of elastic material.

5. An apparatus as in claim 3, wherein said elongated tab is made of plastic material.

6. An apparatus as in claim 1, wherein said elongated tab features printed matter such as a distinctive color, trademark, or logo.
